(19) United States
(12) Patent Application Publication
(10) Pub. No.: US 2011/0047940 A1
(43) Pub. Date: Mar. 3, 2011

(54) RECLOSABLE CONTAINER

(75) Inventors: Simon R. GAINEY, Media, PA (US); Rita Dombroski, Claymont, DE (US); Thomas E. Wells, Chadds Ford, PA (US); Gary N. Langer, New City, NY (US); Thomas Tedeschi, JR., Brewster, NY (US); Kofi N. Ampadu, Mount Vernon, NY (US)

(73) Assignee: KRAFT FOODS GLOBAL BRANDS LLC, Northfield, IL (US)

(21) Appl. No.: 12/623,837

(22) Filed: Nov. 23, 2009

Related U.S. Application Data
(60) Provisional application No. 61/239,688, filed on Sep. 3, 2009.

(51) Int. Cl. B65B 5/00; B65D 5/08; B32B 3/00; B32B 3/10

(52) U.S. Cl. 53/467; 229/120.01; 428/152; 428/131

(57) ABSTRACT

A container for retaining one or more inner packets having an outer package having at least a back and a flap, the flap including a first layer and a second layer which are joined along side edges thereof to create a pocket in the flap that is open along only one side, wherein the flap is divided from the back by a fold line; and at least one inner packet slot configured to receive the inner packet, the inner packet slot being defined between the first and second layers of the flap; whereby an opened inner packet can be partially inserted behind the inner packet slot and into the pocket between the first and second layers of the flap of the outer package, so that when the outer package is folded along the fold line, the inner packet is folded against itself and is pinched shut to retain its contents. Methods and blanks are also included.

### CROSS-REFERENCE TO RELATED APPLICATION

This patent application is related to and claims priority from provisional patent application No. 61/239,688, filed Sep. 3, 2009 and entitled Reclosable Container, the contents of which are hereby incorporated herein by reference in their entirety for all purposes.

### FIELD

The invention relates to containers, and in particular to containers having a means to keep opened inner packets sealed.

### BACKGROUND

Reclosable containers that include a plurality of inner packets or liners that contain product are known in the art. Some containers can be opened and closed by the use of locking flaps and made of paperboard.

Containers of this type are susceptible to spillage of product when the inner packet has granular or powdered material and is opened and returned to the container. Containers of this type do not form adequate seals to hold any inner product that has spilled.

Accordingly, there is a desire and need for a container that can be reliably closed and additionally can seal an opened inner packet from spillage.

### SUMMARY

A reclosable container is provided that can be reliably closed and can seal one or more opened inner packets.

One embodiment provides container for one or more inner packets having an outer package, the outer package having at least a back and a flap, the flap including a first layer and a second layer which are joined along side edges thereof to create a pocket in the flap that is open along only one side, wherein the flap is divided from the back by a fold line; and at least one inner packet slot configured to receive the inner packet, the inner packet slot being defined between the first and second layers of the flap; whereby an opened inner packet can be partially inserted behind the inner packet slot and into the pocket between the first and second layers of the flap of the outer package, so that when the outer package is folded along the fold line, the inner packet is folded against itself and is pinched shut to retain its contents.

Other embodiments can include the flap of the outer package being a second front panel, the fold line being a first fold line, the outer package further adding a first front panel, the first front panel being divided from the back along a second fold line, the first front panel being opposed to the second front panel; and two side panels, the first side panel being divided from the back along a third fold line and having an arcuate edge opposing the third fold line, and the second side panel being divided from the back along a fourth fold line and having an arcuate edge opposing the fourth fold line to define a convex shape to the front panel.

In other embodiments, the back panel can also have a pair of back arcuate edges to define a pair of side panels and a second convex shape to the back panel.

The container can be constructed from one blank made of a material selected from the group consisting of paper, cardboard, plastic, paperboard-plastic composites, fabric, leather, vinyl, and combinations thereof.

Other features can include an inner packet slot downwardly arcuate and has a straight transverse fold bendable at each end of the arc. Alternately, the slot can be upwardly arcuate.

Methods of storing an inner packet within the reclosable container can include providing a package, the package including a back panel, and a front panel including an external layer and an internal layer, the front panel being continuously connected to the back panel along a top edge; providing a inner packet slot in the front panel; providing an unsealed inner packet, the inner packet including a product; inserting a portion of the inner packet into said inner packet slot such that the portion of the inner packet is between the internal layer and the external layer of the front panel; closing the package by acutely folding the front panel along the top edge; and pinching the inner packet closed between the front panel and the back panel along the top edge.

In one method, front panel being a second front panel, the package further comprising a first front panel and two side panels, the first front panel of the package including a slot, the second front panel at least partially overlapping the first front panel when it is folded at the top edge.

Embodiments also include blanks that can have a back panel; a first front panel continuous with a lower edge of the back panel and defined by a first fold line; first and second attachment flaps, continuous with edges of the back panel and define by second and third fold lines; a second front panel continuous with a top edge of the back panel and defined by a forth fold line, the second front panel having a fifth transverse fold line, at about a vertical midway point to define substantially symmetrical lower and upper portions; and an arcuate tab along a top edge of the upper portion of the second front panel.

The blanks can also have arcuate lines in the first and second attachment flaps scored that originate at each end of each the second and third fold lines. Similarly, the back panel can also have scored arcuate lines that originate at each end of each the second and third fold lines.

Alternate features can include the arcuate tab further having a sixth fold line between ends of the arc. Also, the front panel further comprises a cut through arcuate slot placed at a point that the slot, when folded 180 degrees along the first fold line, would be positioned at a point that would approximate the point where the fifth fold line would be positioned, when second front panel is folded 180 degrees along the fourth fold line.

Other features will become more apparent to persons having ordinary skill in the art to which the container pertains and from the following description and claims.

### BRIEF DESCRIPTION OF THE DRAWINGS

The foregoing features, as well as other features, will become apparent with reference to the description and figures below, in which like numerals represent like elements, and in which:

FIG. 1 is a front view of a closed exemplary container;

FIG. 2 is a front view of the container of FIG. 1 in an open position;

FIG. 3A is a front view of the container of FIG. 1 with an inner packet disposed in a flap cavity;

FIG. 3B is a cross-section of the container of FIG. 1 taken along line 3B-3B with an inner packet pinched shut using the flap;

FIG. 4 is a front view of a blank;

FIG. 5 is a front view of an alternate blank;

FIG. 6 is a front view of a container in an open position having and alternate slot; and

FIG. 7 is a front view of a container in an open position having a plurality of slots.

### DETAILED DESCRIPTION OF PREFERRED EMBODIMENTS

Referring now to the figures, like elements are represented by like numerals throughout the several views.

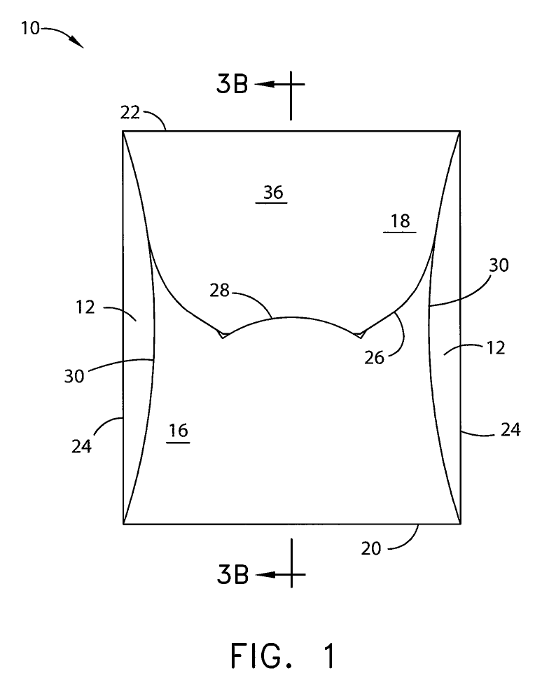

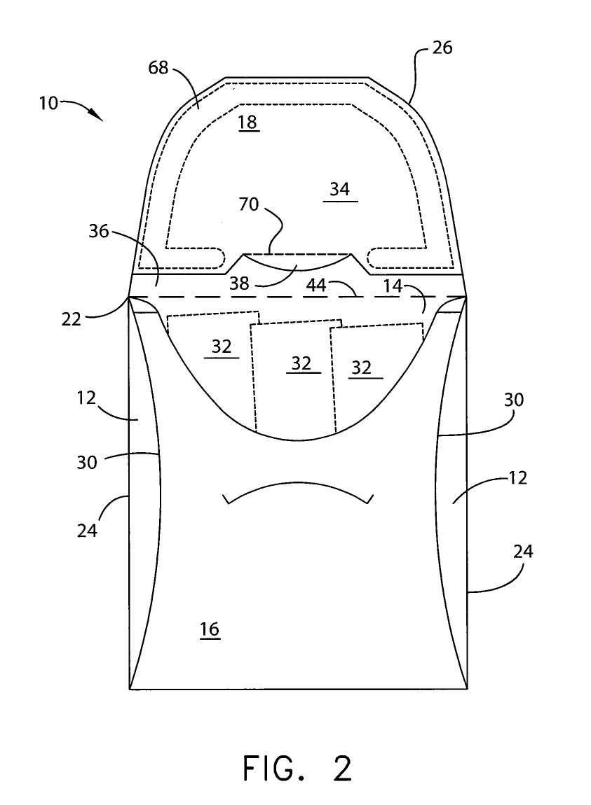

FIG. 1 shows an exemplary embodiment of a closed container 10. Container 10 includes a front, two side panels 12 and a back 14. The front can have a first front panel 16 and a second front panel 18. First front panel 16 can be smaller than back 14 and can continuously adjoin back 14 along a bottom edge 20. Back 14 can continuously adjoin second front panel 18 along a top edge 22 and each side panel 12 along a respective side edge 24. First front panel 16 can also be connected to each of the two side panels 12, and at least a portion of each edge 30 between first front panel 16 and each of the side panels 12 can be arcuate. Arcuate edges 30 connecting first front panel 16 and side panels 12 result in a bowing out of first front panel 16 so that it is at least partially outwardly-convex, defining a cavity between first front panel 16 and back 14. This allows an area for one or more inner packets 32 (FIG. 2) containing products to be placed therein. Although any number of products can be placed within inner packet 32, examples herein can include granulated or powdered drink mixes.

First front panel 16 can also include a slot 28 for receiving a lower edge 26 of second front panel 18 to close container 10. Second front panel 18 can at least partially overlap first front panel 16. In exemplary embodiments, when container 10 is initially purchased and is unopened, an adhesive means can be used to retain the first front panel 18 over second front panel 16. Adhesive retaining means can include such things as cold glue, hot melt glue, tape, stickers, labels, band overwrap, shrink overwrap, and the like. In such embodiments, slot 28 is unused until the adhesive retaining means is broken.

The combination of slot 28 and reclosing edge 26 can generally be referred to as reclosing mechanism. The exact position of slot 28 on first front panel 16 can vary, though it has been found that placement near the apex of the arcuate edge 30 is preferable and can provide a closure that will not readily open by itself when upside down or inverted, when first front panel 16 is folded to an acute angle, when container 10 is dropped, or when container 10 is subjected to compressive forces. The folding angle can adjust to accommodate the convex curvature of container 10. The reclosing mechanism can be configured for a consumer to open using one hand.

Container 10 can be made from a variety of materials such as a single sheet of foldable material (blank). Preferably, container 10 is made of paperboard of the type conventionally used in food containers or product packages, and more specifically, can be made of 14 point paperboard (approximately 0.3 mm thick). Other materials can include plastic, paperboard-plastic composites, cardboard, fabric, leather, vinyl and the like. Container 10 can additionally include texture on one or more of the surfaces, indicia, or other designs to make the package aesthetically pleasing to consumers.

FIG. 2 shows the package of FIG. 1 in an open position. FIG. 2 also shows a plurality of internal packets 32, which may contain, for example, powdered or granulated products, such as powdered beverage mix or powdered juice or coffee, salad dressing, instant pudding or gelatin mix, ice cream toppings, desserts and dessert toppings, sprinkles, cookie crumbs, confections such as gum sticks, or other products.

Referring back to FIG. 2, in some embodiments, second front panel 18 can have at least two layers: an interior layer 34 and an exterior layer 36, which can be joined at the edges, defining an interior cavity. The edges can be joined by an adhesive layer 68 in a number of manners such as hot melt glue, cold glue, adhesive tape, and the like. Interior layer 34 of second front panel 18 defines an inner packet slot 38. Inner packet slot 38 is sized to accommodate at least a portion of one or more inner packets 32. In one specific example, inner packet 32 is a packet with a powdered drink mix that may be torn open at its upper end. Inner packet 32 may be, for example, two centimeters wide and inner packet slot 38 is at least that wide.

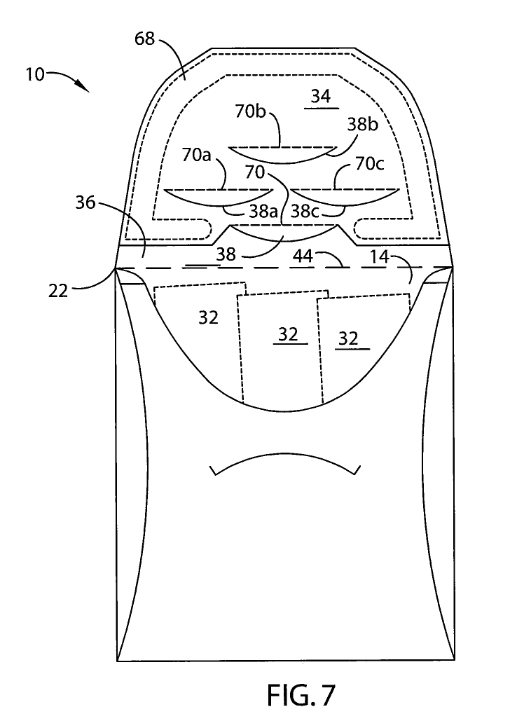

As shown in FIG. 2, inner packet slot 38 can be defined, in part, by an unattached arcuate portion of an edge of layer 26. Inner packet slot 38 may alternatively be trapezoidal, or may include a tab that can be completely folded under to provide a straight edge under which the inner packet 32 containing product can be slipped. As shown, inner packet slot 38 has a score line 70 to allow the arcuate portion of inner packet slot 38 to be bent outwardly forming a tab, thus facilitating easier insertion of inner packet 32. Additional inner packet slots, such as shown in FIG. 7, can be optionally provided and allow a consumer to save a plurality of opened inner packets 32 containing e.g., a variety of flavors of powdered beverage within the plurality of slots. The additional inner packet slots can be made by making cuts (arcuate cuts shown) in interior layer 34. Additionally, score lines 70 can also be added to form outwardly bent tabs as described herein.

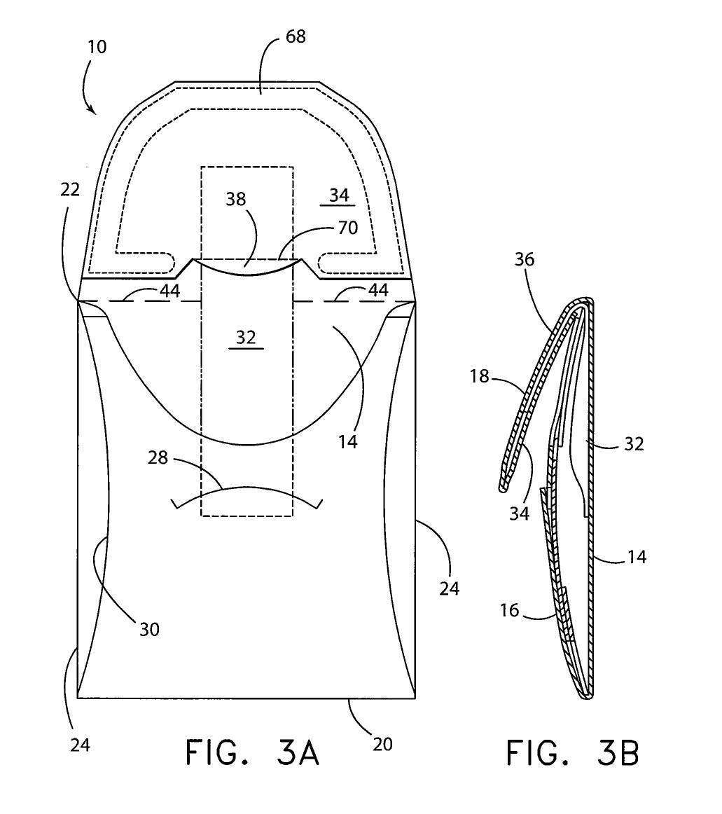

After an inner packet 32 has been opened by tearing its upper end, the upper end may be inserted within inner packet slot 38, between interior layer 34 and exterior layer 36 of second front panel 18, as shown in FIG. 3. Inner packet slot 38 holds inner packet 32 in place, restricting or eliminating movement thereof.

FIG. 3B shows that as second front panel 18 is acutely folded at top edge 22 to overlap first front panel 16, inner packet 32 is also folded, pinching the inner packet 32 closed, thus providing a releasable seal.

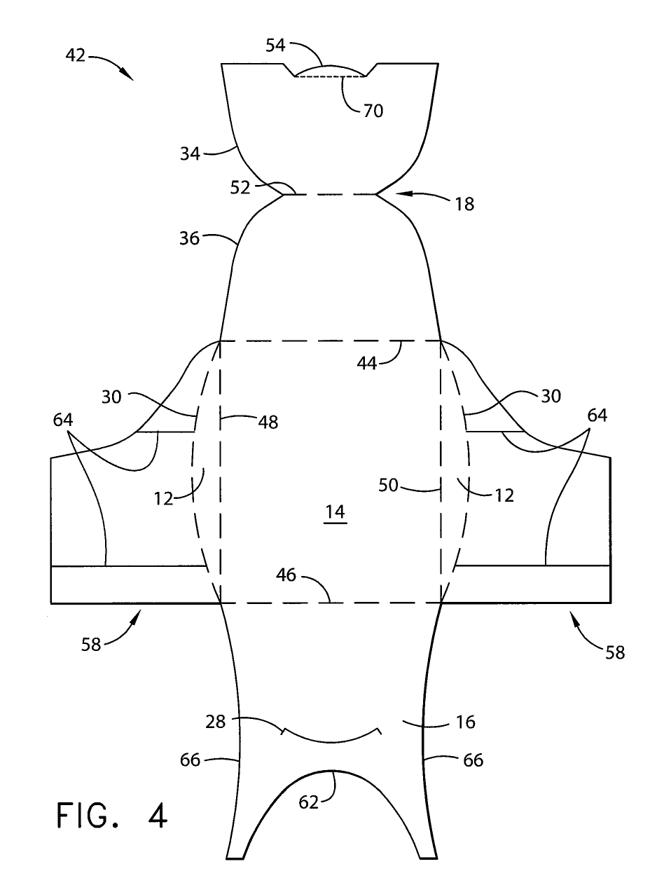

Referring now to FIG. 4, an example of a blank 42 for container 10 is shown. As shown herein, container blank 42 can be formed from a single sheet of foldable material. Preferably, container blank 42 is made of paperboard of a type conventionally used in food containers, such as 14 point paperboard. Other materials can also be used including plastic, paperboard-plastic composites, cardboard, fabric, leather, vinyl, and the like. Additionally, textures on one or more of the surfaces can be provided in the form of embossing, debossing, coating, and matte or gloss finishing. Indicia or other designs can be provided on container blank 42 so that such indicia or designs are visible on the inside and/or outside of container 10.

As FIG. 4 illustrates, container blank 42 includes a back 14, preferably in the shape of a rectangle or square. Length and width of back 14 can be around 10 centimeters to allow for the container to fit into purses, pockets, briefcases, and to be otherwise conveniently sized for transportation. Length and width of back 14 can be greater or smaller, depending on the specific application contemplated, such as may be necessary to accommodate smaller or larger products. Container blank 42 includes two opposing side panels 12, a first front panel 16, and a second front panel 18 which are adjacent to and integrally connected to the back 14 by fold lines 44, 46, 48, and 50. Fold lines 48 and 50 make up side edges 24 in FIG. 1. Further, fold line 44 corresponds to top edge 22 and fold line 46 corresponds to bottom edge 20 of FIG. 1.

Referring back to FIG. 4, back 14, as illustrated, is larger than the first front panel 16, and first front panel 16 adjoins back 14 along a fold line 46 along the bottom of back 14. First front panel 16 includes a slot 28 cut through first front panel 16 and positioned and shaped to engage reclosing edge 26, or fold line 52 in FIG. 4 of second front panel 18. As discussed in connection with FIG. 1, slot 28 varies in distance from fold line 46 depending on the distance of fold line 52 from fold line 44. First front panel 16 includes two arcuate opposing edges 66 to approximately match arcuate edges 30 of side panels 12. These opposing edges 66 are adjacent to fold line 46. Edge 62 of first front panel 16, which opposes fold line 46, is shown in FIG. 4 as having a hyperbolic shape. Nevertheless, this particular edge can be a straight line, have a trapezoidal cut out, or include other shapes.

Container blank 42, as illustrated, also includes two side panels 12. Side panels 12 are divided from back 14 along fold lines 48 and 50, located on edges of the back 14 opposing one another, and each adjacent to first front panel 80. Fold lines 48 and 50, as shown, are straight edges, which allow back 14 to remain flat when the package is assembled and contains product so as to minimize the amount of space the package occupies. Side panels 12 additionally include precisely scored arcuate edges 30 which define the depth of the package and provide a convex shape to first front panel 16. In exemplary embodiments, the distance from fold line 48 or 50 to the apex of arcuate edge 30 of side panel 12 is about one centimeter to allow the container to be easily transported in a small purse, bag, or pocket. The distance from fold line 48 or 50 to the apex of arcuate edge 30 of side panel 12 varies depending on inner packet 32 to be contained within the container 10. It is this distance from fold line 48 or 50 to the apex of the arcuate edge 30 that gives the package its depth. Furthermore, the distance from fold line 48 to the apex of the arcuate edge 30 of the associated side panel 12 is equal to the distance from fold line 50 to the apex of the corresponding arcuate edge 30 of the side panel 12 associated with fold line 50.

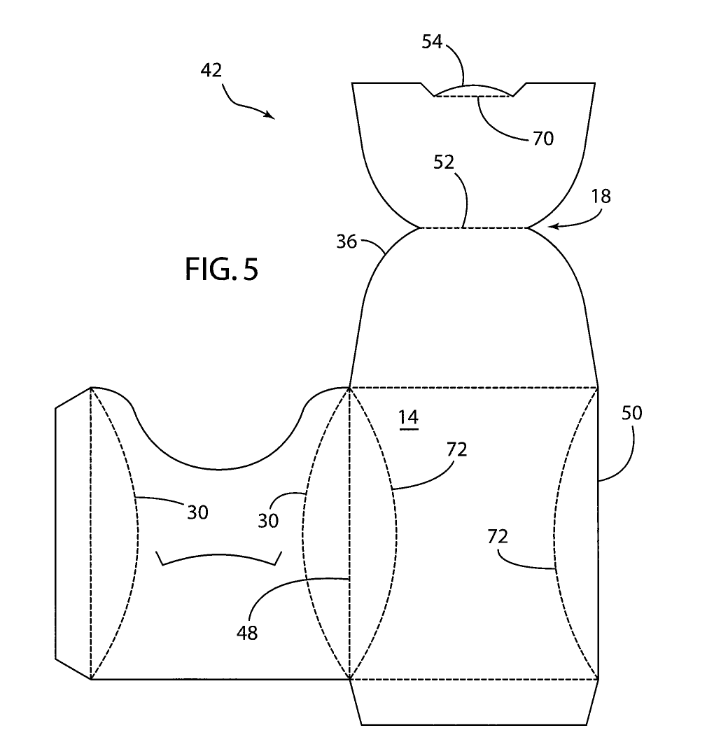

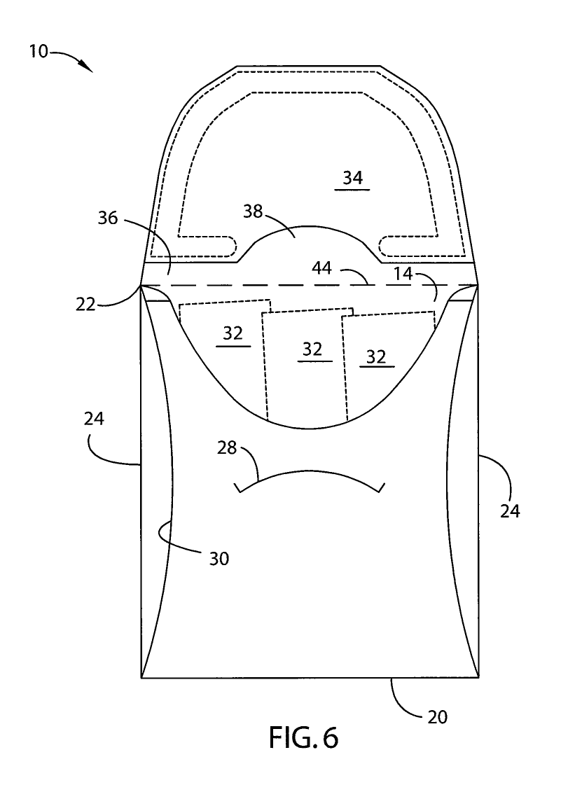

As shown in FIG. 5, optionally scored back arcuate edges 72 can further define the depth of the package by providing a second convex shape to back 14.

Side panels 12 can each be connected to an attachment flap 58 along the scored edge using adhesive means described herein. Attachment flaps 58 are folded into the inside of the container 10 when it is assembled and provides a means by which first front panel 16 can be joined to side panels 12. Each attachment flap 58 can have a straight edge 56 opposing arcuate edge 30 and a straight edge 60 adjacent to arcuate edge 30 near fold line 46. Further, each attachment flap 58 has a contoured edge 54 adjacent to the arcuate edge 30 near fold line 44. This edge 54 is contoured to substantially match hyperbolic edge 62 of first front panel 16 when container blank 42 is folded to form a container. When container 10 is constructed from container blank 42 as shown in FIG. 4, attachment flaps 58 can substantially overlap one another. The amount of overlap may vary depending on the desired type and amount of materials to be used and the amount of support desired. Additionally, in exemplary embodiments, attachment flaps 58 can include more than two relief cuts 64, or fewer than two relief cuts 64, depending on the type of material selected and its flexibility.

Container 10 can also include a second front panel 18 which, as shown in FIG. 4, includes at least two layers, an exterior layer 36 and an interior layer 34 of second front panel 18. When shown spread out in the container blank 42, exterior layer 36 and interior layer 34 are adjacent to and integrally connected to one another by a transverse fold line 52, and substantially form an hourglass shape. As shown in FIG. 4, interior layer 34 and exterior layer 36 include partially arcuate edges, although the exact shape of the edges of interior layer 34 and exterior layer 36 vary depending on the application and overall shape of the container 10. For example, second front panel 18 can be contoured to match the shape of first front panel 16, or it can differ in shape from the shape of first front panel 16. In FIG. 4, fold line 52 divides second front panel 18 into symmetrical first and second portions, where each portion includes a narrow edge and a wide edge. The first portion, or exterior layer 36, is divided from back 14 along its wide edge, or fold line 44. Fold line 52, located across the narrow part of the second front panel 18, comprises reclosing edge 26 in FIG. 1, and is received by slot 28 of first front panel 16 to close the package.

In preferred embodiments, the second portion of the second front panel, or interior layer 34, includes an inner packet slot 38. When the container blank 42 is folded to create container 10, inner packet slot 38 allows the interior layer 34 and the exterior layer 36 to be easily separated to receive an inner packet 32 containing product between the two layers. Inner packet slot 38 can vary in size, creating a wider or narrower inner packet slot 38. As shown in FIG. 4, inner packet slot can located in approximately the center of the wide edge of the second portion of the second front panel, and has an arcuate shape. As previously discussed, inner packet slot 38 can have other shapes, depending on the specific application contemplated.

To create the container 10 as shown in FIGS. 1-3, slot 28 is cut or scored through first front panel 16 of container blank 42 in FIG. 4. Interior layer 34 is folded down to exterior layer 36 of second front panel 18 along fold line 52 and secured in place. Again, this can be secured using an adhesive means described herein. A portion of interior layer 34 and exterior layer 36, including at least the location of inner packet slot 38, are not joined to allow for receipt of an open inner packet 32 containing product. Container blank 42 is folded along fold lines 44, 46, 48, and 50. Relief cuts 64 in attachment flaps 58 are cut, and attachment flaps 58 are folded towards one another along arcuate edges 30. Attachment flaps 58 overlap and are joined to one another using an adhesive or the like. Edges 66 of first front panel 16 are joined to arcuate edges 30 of side panels 12, giving first front panel 16 an at least partially outward-convex shape. First front panel 16 is joined to attachment flaps 58. Second front panel 18 is folded down along fold line 44 and reclosing edge 26 (fold line 52 in FIG. 4) is tucked into slot 28 on first front panel 16 to close container 10.

While preferred embodiments have been described in detail, variations and modifications can be effected within the scope of the invention.

We claim:

1. A container for retaining one or more inner packets, the container comprising:
an outer package, the outer package having at least a back and a flap, the flap including a first layer and a second layer which are joined along side edges thereof to create a pocket in the flap that is open along only one side, wherein the flap is divided from the back by a fold line; and
at least one inner packet slot configured to receive the inner packet, the inner packet slot being defined between the first and second layers of the flap;
whereby an opened inner packet can be partially inserted behind the inner packet slot and into the pocket between the first and second layers of the flap of the outer package, so that when the outer package is folded along the fold line, the inner packet is folded against itself and is pinched shut to retain its contents.

2. The container of claim 1, the flap of the outer package being a second front panel, the fold line being a first fold line, the outer package further comprising:
a first front panel, the first front panel being divided from the back along a second fold line, the first front panel being opposed to the second front panel; and
two side panels, the first side panel being divided from the back along a third fold line and having an arcuate edge opposing the third fold line, and the second side panel being divided from the back along a fourth fold line and having an arcuate edge opposing the fourth fold line to define a convex shape to the front panel.

3. The container of claim 2, wherein the back panel further comprises a pair of back arcuate edges to define a pair of side panels and a second convex shape to the back panel.

4. The container of claim 1, wherein the container is constructed from one blank made of a material selected from the group consisting of paper, cardboard, paperboard-plastic composites, plastic, fabric, leather, vinyl, and combinations thereof.

5. The container of claim 1, wherein there are greater than 1 inner packet slots.

6. The container of claim 1, wherein the inner packet slot is downwardly arcuate and has a straight transverse fold bendable at each end of the arc.

7. The container of claim 1, wherein the inner packet slot is upwardly arcuate.

8. A method of storing an inner packet within a reclosable container, the method comprising:
providing a package, the package including a back panel, and a front panel including an external layer and an internal layer, the front panel being continuously connected to the back panel along a top edge;
providing an inner packet slot in the front panel;
providing an unsealed inner packet, the inner packet including a product;
inserting a portion of the inner packet into said inner packet slot such that the portion of the inner packet is between the internal layer and the external layer of the front panel;
closing the package by acutely folding the front panel along the top edge; and
pinching the inner packet closed between the front panel and the back panel along the top edge.

9. The method of claim 8, front panel being a second front panel, the package further comprising a first front panel and two side panels, the first front panel of the package including a slot, the second front panel at least partially overlapping the first front panel when it is folded at the top edge.

10. The method of claim 9, wherein the step of closing the package by folding the second front panel along the top edge further comprises inserting at least a portion of the second front panel into the slot of the first front panel.

11. The method of claim 8, wherein the inner packet comprises a product selected from the group consisting of a single serving size of a beverage and a single serving size of a food product.

12. A blank for forming a container, comprising:
a back panel;
a first front panel continuous with a lower edge of the back panel and defined by a first fold line;
first and second attachment flaps, continuous with edges of the back panel and define by second and third fold lines;
a second front panel continuous with a top edge of the back panel and defined by a forth fold line, the second front panel having a fifth transverse fold line, at about a vertical midway point to define substantially symmetrical lower and upper portions; and
an arcuate tab along a top edge of the upper portion of the second front panel.

13. The blank of claim 12, wherein the first and second attachment flaps further comprise scored arcuate lines that originate at each end of each the second and third fold lines.

14. The blank of claim 13, wherein the back panel further comprises scored arcuate lines that originate at each end of each the second and third fold lines.

15. The blank of claim 12, wherein the arcuate tab further comprises a sixth fold line between ends of the arc.

16. The blank of claim 12, wherein the front panel further comprises a cut through arcuate slot placed at a point that the slot, when folded 180 degrees along the first fold line, would be positioned at a point that would approximate the point where the fifth fold line would be positioned, when second front panel is folded 180 degrees along the fourth fold line.

17. A blank for forming a container, comprising:
a back panel;
a first front panel continuous with a side edge of the back panel and defined by a first fold line;
an attachment flap, continuous with a lower edge of the back panel and define by a second fold line;
a second front panel continuous with a top edge of the back panel and defined by a forth fold line, the second front panel having a fifth transverse fold line, at about a vertical midway point to define substantially symmetrical lower and upper portions; and
an arcuate tab along a top edge of the upper portion of the second front panel.
